(19) United States
(12) Patent Application Publication
(10) Pub. No.: US 2009/0168754 A1
(43) Pub. Date: Jul. 2, 2009

(54) Systems and methods for WiMAX and 3GPP interworking by using GGSN

(76) Inventor: Chang Hong Shan, Changning (CN)

Correspondence Address: SCHUBERT, OSTERRIEDER & NICKELSON, PLLC;c/o CPA Global, P.O. BOX 52050, MINNEAPOLIS, MN, 55402, US

(21) Appl. No.: 12/006,016

(22) Filed: Dec. 28, 2007

(51) Int. Cl. H04L 12/66

(52) U.S. Cl. 370/352

(57) ABSTRACT

Embodiments include systems and methods for interoperability between WiMax and 3GPP systems reusing a GGSN. Embodiments comprise implementing GTP functions within the ASN of a WiMAX system to enable communication of data between the ASN Gateway (ASN-GW) of the ASN and the GGSN of the 3GPP system. Embodiments also implement a WiMAX AAA server in the 3GPP system to enable communication of control information between ASN-GW and the 3GPP system.

### FIELD

This written description is in the field of wireless communications. More particularly, the description is in the field of interoperability within Worldwide Interoperability for Microwave Access (WiMAX) and Third Generation Partnership Project (3GPP) systems by using a Gateway GPRS (General Packet Radio Service) Support Node (GGSN).

### BRIEF DESCRIPTION OF THE DRAWINGS

Aspects of the invention will become apparent upon reading the following detailed description and upon reference to the accompanying drawings in which like references may indicate similar elements:

FIG. 1 depicts a WiMAX network.

FIG. 2A depicts a first roaming configuration with the GGSN in the visited communications network.

FIG. 2B depicts a second roaming configuration with the GGSN in the home communications network.

FIG. 3 depicts a procedure for making a connection between a WiMAX network and a 3GPP network.

FIG. 4A-4E depict how layers are modified to enable communications between the WiMAX network and 3GPP network.

FIG. 5 depicts a handover procedure for when a mobile station moves from one Access Service Network Gateway (ASN-GW) to another ASN-GW.

FIG. 6 depicts a diagram showing the connections that exist before and after the handover of FIG. 5 is completed.

FIG. 7 depicts a different handover procedure for when a mobile station moves from one ASN-GW to another ASN-GW.

FIG. 8 depicts a diagram showing the connections that exist before and after the handover of FIG. 7 is completed.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Global System for Mobile communications (GSM) is a standard for mobile communications by way of mobile phones used by most of the world. The General Packet Radio Service (GPRS) system is used by GSM Mobile phones for transmitting Internet Protocol (IP) packets. The GPRS Core Network is the centralised part of the GPRS system and also provides support for WCDMA (Wide Band Code Division Multiple Access) based 3G (3^{rd} Generation) networks. The GPRS core network is an integrated part of the GSM core network. The IP protocol used by the GPRS network is called GPRS Tunnelling Protocol (GTP). This protocol enables end users of a GSM or WCDMA network to move from place to place while continuing to connect to the internet as if from one location at the Gateway GPRS Support Node (GGSN). It does this by carrying the subscriber's data from the subscriber's current Serving GPRS Support Node (SGSN) to the GGSN which is handling the subscriber's session.

A Gateway GPRS Support Node (GGSN) acts as an interface between the GPRS backbone network and the external packet data networks (radio network and the IP network). It converts the GPRS packets coming from the SGSN into the appropriate packet data protocol (PDP) format (e.g. IP or X.25) and sends them out on the corresponding packet data network. In the other direction, PDP addresses of incoming data packets are converted to the GSM address of the destination user. The readdressed packets are sent to the responsible SGSN. For this purpose, the GGSN stores the current SGSN address of the user and his or her profile in its location register. The GGSN is responsible for IP address assignment and is the default router for the connected UE (User Equipment). The GGSN also performs authentication and charging functions. A Serving GPRS Support Node (SGSN) is responsible for the delivery of data packets from and to the mobile stations within its geographical service area. Its tasks include packet routing and transfer, mobility management (attach/detach and location management), logical link management, and authentication and charging functions.

The 3rd Generation Partnership Project (3GPP) is a collaboration between groups of telecommunications associations, to make a globally applicable third generation (3G) mobile phone system specification within the scope of the International Mobile Telecommunications-2000 project of the International Telecommunication Union (ITU). 3GPP specifications are based on evolved Global System for Mobile Communications (GSM) specifications and are publicly available.

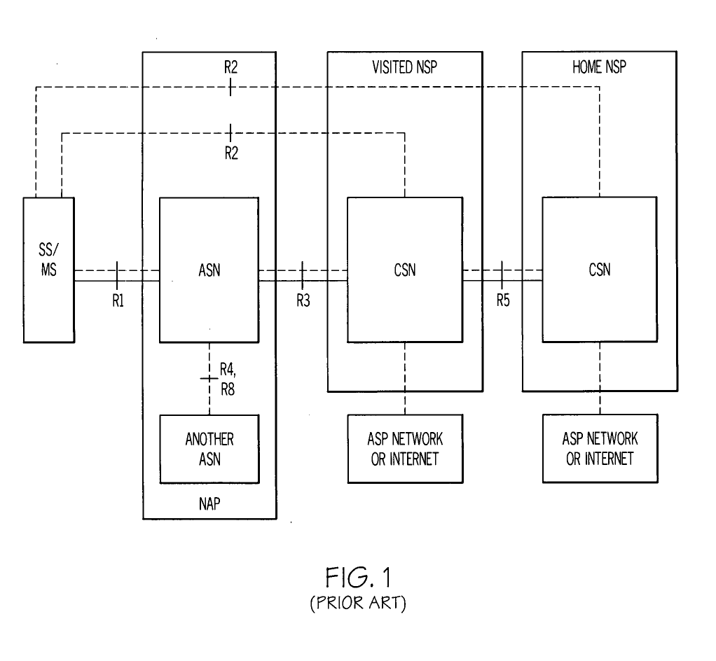

A different system is WiMAX, the Worldwide Interoperability for Microwave Access. WiMAX is a telecommunications technology aimed at providing wireless data over long distances in a variety of ways, from point-to-point links to full mobile cellular type access. WiMAX provides the delivery of last mile wireless broadband access as an alternative to cable and DSL. The WiMAX Forum has defined an architecture that defines how a WiMAX network connects with other networks, and a variety of other aspects of operating such a network, including address allocation, authentication, etc. An overview of the architecture is shown in FIG. 1. The following acronyms for components of a WiMAX network are defined and used herein:

SS/MS: the Subscriber Station/Mobile Station

ASN: the Access Service Network

BS: Base station, belongs to ASN

ASN-GW: ASN Gateway

CSN: the Connectivity Service Network

HA: Home Agent, belongs to CSN

AAA: Authentication, Authorization, and Accounting (AAA) Server, belongs to CSN

NAP: a Network Access Provider

NSP: a Network Service Provider plus a number of interconnections (or reference points) between these, labeled R1 to R5 and R8.

Embodiments include systems and methods for interoperability between WiMax and 3GPP systems reusing a GGSN. Embodiments comprise implementing GPRS Tunnelling Protocol (GTP) functions within the ASN of a WiMAX system to enable communication of data between the ASN Gateway (ASN-GW) of the ASN and the GGSN of the 3GPP system. Embodiments also implement a WiMAX AAA server in the 3GPP system to enable communication of control information between ASN-GW and the 3GPP system.

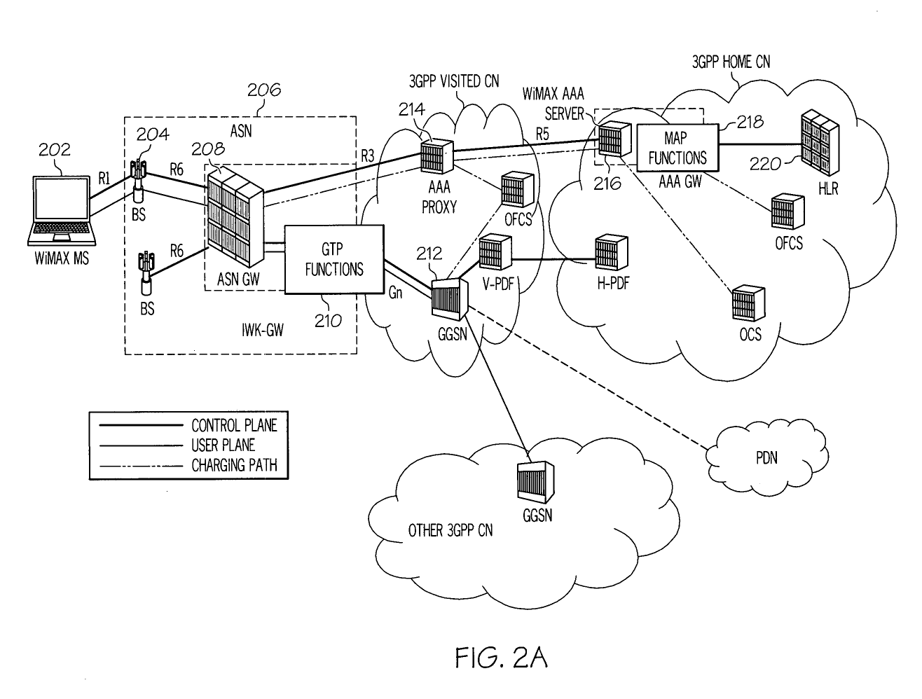

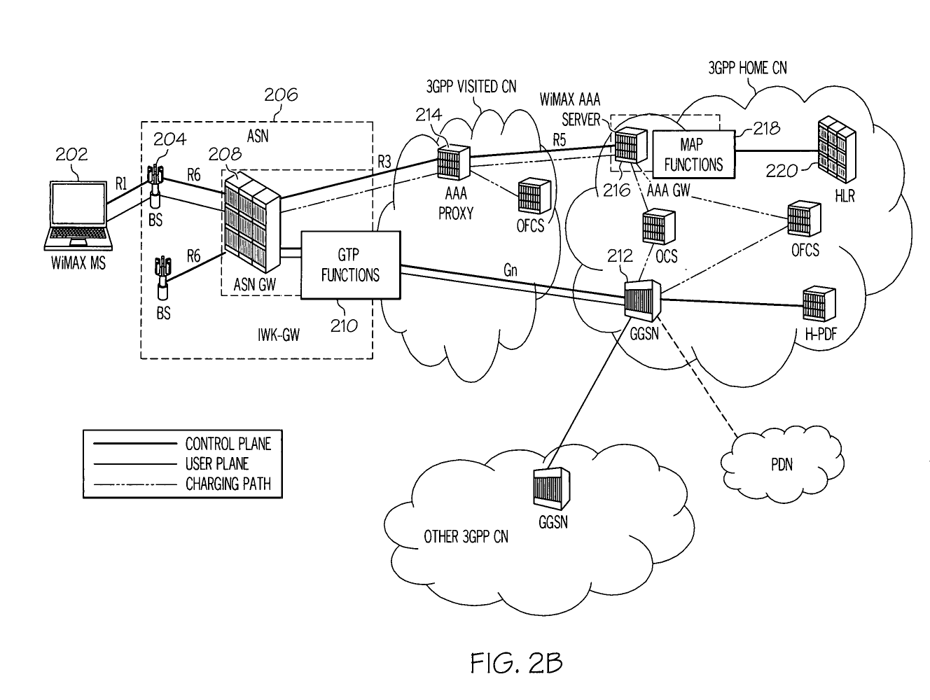

FIG. 2A and FIG. 2B show communications links between a WiMAX network and a 3GPP network. FIG. 2A shows a roaming configuration wherein the GGSN 212 is in the visited Communication Network (CN). FIG. 2B shows a roaming configuration wherein the GGSN 212 is in the home CN. As shown in these figures, GPRS Tunneling Protocol (GTP) functions 210 are implemented in the Access Service Network (ASN) 206 of a WiMAX system. This is to facilitate communications between an ASN Gateway (ASN-GW) and a GGSN to enable interoperability between the WiMAX system and the 3GPP system.

Thus, for example, a WiMAX Mobile Station (MS) 202 communicates with a WiMAX Base Station (BS) 204 which is part of ASN 206. An ASN Gateway (ASN-GW) 208 makes connections between the base stations and the external 3GPP system. WiMAX ASN-GW 208 must implement GTP functions 210 to support Packet Data Protocol (PDP) procedures for establishing a data path between ASN-GW 208 and GGSN 212. These functions are defined by the 3GPP releases that are promulgated by the Partnership. Implementation of GTP functions 210 by ASN 206 enables communication with the GGSN 212 that is in the 3GPP network. The implementation enables the MS to use the same IP address when it moves between ASN-GWs, as will be described below. Implementation also enables mapping of Quality of Service (QOS) rules between ASN-GW and GGSN. GGSN 212 may be in the visited CN as in FIG. 2A or in the home CN as in FIG. 2B.

In either FIG. 2A or 2B, an Authentication, Authorization, and Accounting (AAA) proxy in the visited Communications Network enables communications between the ASN-GW and a WiMAX AAA server 216 that is implemented in the Home Communication Network. The WiMAX AAA server 216 stores subscriber information such as root key and charging quota. It also terminates Extension Authentication Protocol (EAP) authentication. The WiMAX AAA server 216 is located in an AAA GW that also comprises a set of Mobile Application Part (MAP) functions 218. The MAP functions 218 enable communication with the Home Location Register (HLR) 220 which stores subscriber information such as root key and charging quota.

FIGS. 2A and 2B also show the different charging paths that are implemented depending upon whether the GGSN is located in the visited or home network. In FIG. 2A, the charging path connects the GGSN with the OFCS in the visited network. In FIG. 2B, the charging path connects the GGSN with the Offline Charging System (OFCS) and the Online Charging System (OCS) in the home network. Both figures also show that other 3GPP networks can be connected through the GGSN. Also, a Public Data Network (PDN) may also be tied in through the GGSN.

Thus, one embodiment is a system for inter-working between a WiMAX communication network and a 3GPP communication network. The WiMAX network, in order to communicate data between the two networks, must implement GTP functions. More specifically, GTP functions implemented in the ASN of the WiMAX network enable communication of data between the ASN-GW of the WiMAX network and the GGSN of the 3GPP network. The 3GPP network, in order to communicate control information between the two networks, must implement a WiMAX AAA server in the 3GPP network. In some configurations, the GGSN may be in the visited CN or in the home CN. As will be explained more fully below, the GGSN is used in a handover procedure when the Mobile Station (MS) moves from one ASN-GW to another.

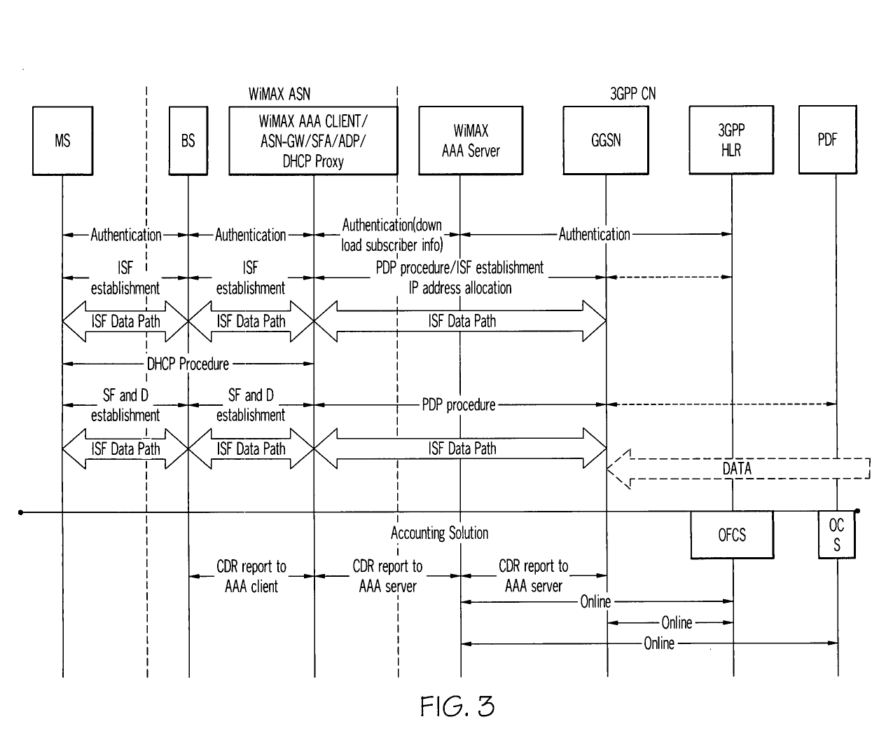

FIG. 3 shows the process for making a connection between a MS connecting to a WiMAX network and to a 3GPP network. The 3GPP CN must contain a WiMAX Authentication, Authorization and Accounting (AAA) server. If there is an Interworking Wireless Local Area Network (I-WLAN) AAA Server in a 3GPP operator's current CN, the network need only upgrade the software of the I-WLAN AAA Server. If the network is to use the existing Home Location Register (HLR) as the consolidated point of subscription data and for generating an authentication vector, then an Interworking (IWK) Function should be added between the WiMAX AAA Server and the HLR. The Home Location Register or HLR is a central database that contains details of each mobile phone subscriber that is authorized to use the GSM core network.

Referring to FIG. 3, the process for making a connection between a MS connecting to a WiMAX network and to a 3GPP network occurs in the following stages. In stage 1, the MS, BS, AAA Client and AAA Server engage in the authentication and authorization procedure. If the authentication method is Extension Authentication Protocol-Subscriber Identity Module (EAP-SIM) or EAP-AKA (Authentication and Key Agreement) and the AAA Server cannot terminate the authentication, the AAA Server must interact with the HLR for help. The details of this stage are described in WiMAX Network Working Group (NWG) release 1.0.0.

Note that the IP address for the MS can be assigned by the AAA Server when the authentication procedure is successfully completed. This IP address can be stored in the Dynamic Host Configuration Protocol (DHCP) Proxy in the ASN-GW. When the MS initiates the DHCP procedure, the DHCP Proxy can assign the IP address to the MS. The subscriber profile including Quality of Service (QoS) and accounting information can be delivered to the ASN-GW while the authentication is successfully completed.

In stage 2, in order to carry upper Internet Protocol (IP) layer signaling, the MS needs to establish one special data path to transfer upper layer signaling such as Session Initiated Protocol (SIP), DHCP and Mobile Internet Protocol (MIP), etc. After successful authentication, the MS, the ASN-GW and the GGSN can trigger initial service flow (ISF) creation. The procedure for making a connection between MS, Base Station (BS) and ASN-GW has been defined in WiMAX NWG release 1.0.0 and can be reused here. However, in order to support the interaction with the GGSN, the ASN-GW must support GTP-C defined in 3GPP. The PDP activation procedure may occur between ASN-GW and GGSN, as described in 3GPP TS29.060. The ISF is used by the MS and the ASN to transfer delay tolerant control traffic such as standards-based IP configuration management and IP client application signaling (e.g. DHCP DISCOVERY, Foreign Agent, Advertisement, Mobile IP Registration, Router Advertisment, SIP signaling etc.) The DHCP address may be assigned by the GGSN, which delivers it to the ASN-GW.

In stage 3, the MS and the ASN can proceed with the IP address assigning procedure by using DHCP. In stage 4, the service flow (SF) and data path (DP) creation procedure occurs between the MS, BS, ASN-GW and GGSN. This procedure has been defined in WiMAX NWG release 1.0.0, and can be reused here. In order to support the interaction with the GGSN, the ASN-GW shall support GTP-C defined in 3GPP. A secondary Packet Data Protocol (PDP) activation procedure may also occur between ASN-GW and GGSN as described in 3GPP TS29.060.

In stage 5, after service flow and data path establishment, once there is traffic related to this service, the traffic can be communicated between peer and peer, peer and proxy, and peer and server. The data routing mechanism between ASN-GW and GGSN will comply with GTP-U as defined in the 3GPP releases. This means that the ASN-GW shall also support GTP-U. The data routing mechanism between MS and ASN-GW has been defined in WiMAX NWG release 1.0.0. In stage 6, the BS, the ASN-GW and the GGSN can be the charging points and they can report charging records to an AAA Client, the AAA Proxy and finally the AAA Server. Then, the AAA Server can report the Charging Data Records (CDR) to the Offline Charging System (OFCS) in offline accounting, and to the Online Charging System (OCS) in online accounting.

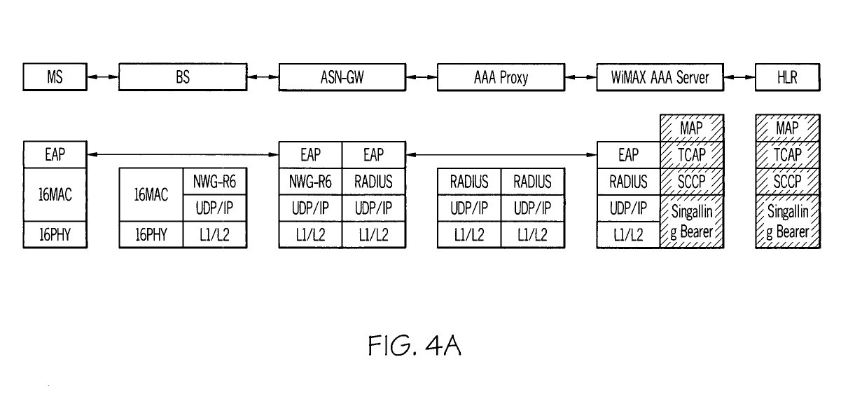

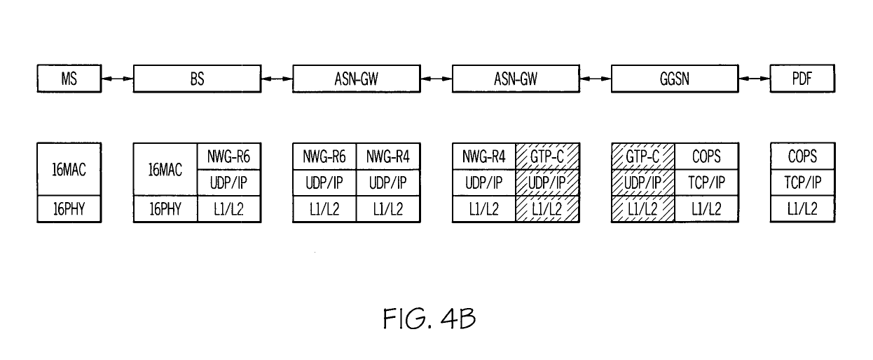

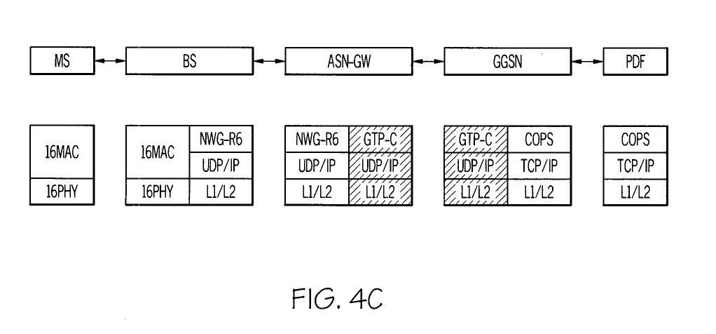

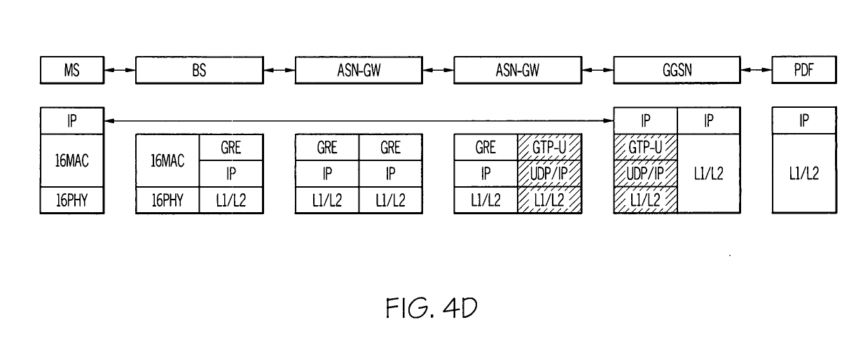

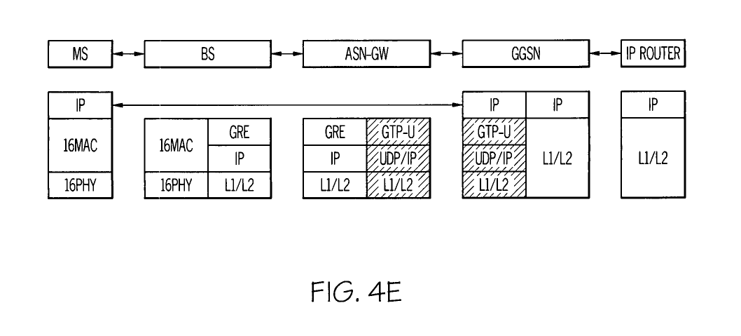

In the control plane, various functions are added at various layers in order to implement embodiments for communication between WiMAX and 3GPP. FIG. 4A shows the Authentication and Authorization Protocol Layer. In all of FIGS. 4A-4E, the shaded boxes represent functionality added to the prior art layer. Thus, functionality is added to the WiMAX AAA server and to the HLR. In particular, we add to the WIMAX AAA server and the HLR, the Mobile Application Part (MAP), the Transaction Capability Application Part (TCAP), the Signaling Connection Control Part (SCCP), and the signal bearer, used to transfer signals and messages. FIG. 4B shows the Mobility and QoS Protocol Layer for an existing R4 Reference Point. FIG. 4C shows the Mobility and Quality of Service (QoS) Protocol Layer for an non-R4 reference point. FIG. 4D shows the User Plane for an existing R4 Interface. FIG. 4E shows the User Plane for a non-R4 Interface. Thus, added to the ASN-GW and to the GGSN at these layers is: GTP, User Datagram Protocol (UDP), L1=Physical Layer, and L2=Media Access Control (MAC) layer.

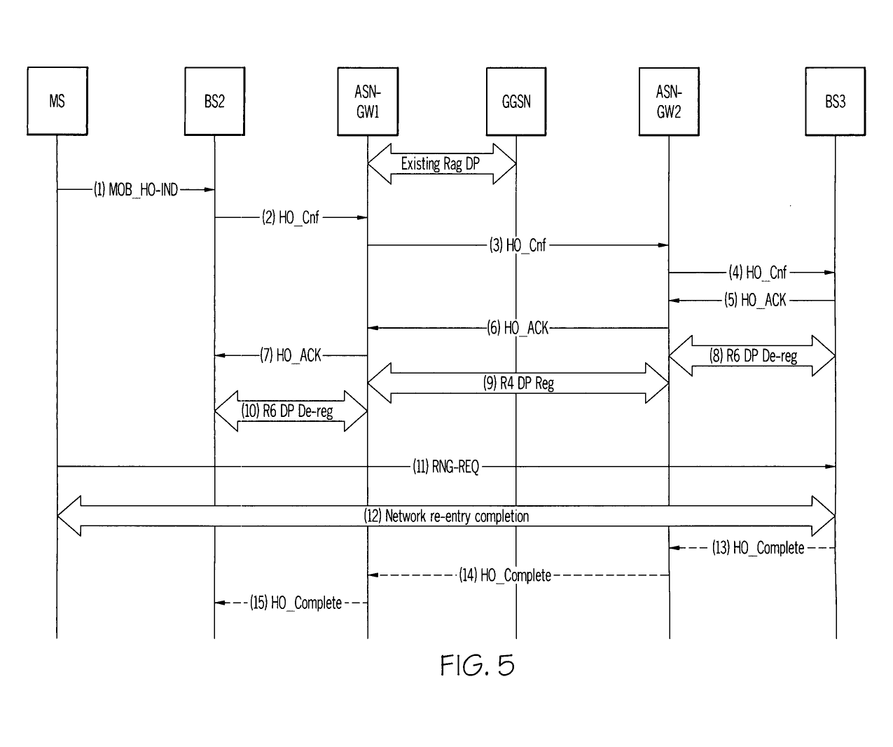

Consider the situation when a mobile station (MS) moves and is handed over from one ASN-GW to another. When this handover occurs, to support data continuity, the new ASN-GW either reestablishes new Rag (a Rag is an interface between ASN-GW and GGSN) by tearing down the old Rag or by reestablishing an R4 connection between two the ASN-GWs. Reestablishment of R6 and R1 is described by WiMAX NWG release 1.0.0. FIG. 5 shows a procedure for establishing an R4 connection. In this scenario, ASN-GW1 is the serving ASN-GW, ASN-GW2 is the target ASN-GW, and the MS moves from ASN-GW1 to ASN-GW2. ASN-GW1 and ASN-GW2 can negotiate to determine if they can establish an R4 data path between the first and second ASN-GW or not. If the R4 data path can be established, then there is no need to break the current Rag between ASN-GW1 and the GGSN. On the other hand, if the R4 path cannot be established between the first and second ASN-GW, then a new Rag is created between the GGSN and ASN-GW2 and the old rag between the GGSN and ASN-GW1 is then broken.

FIG. 5 show registration and deregistration in a first handover procedure, wherein an R4 path is set up between ASN-GW1 and ASN-GW2, and the connection between ASN-GW1 and the GGSN in the 3GPP is not broken. The steps are as follows:

(1) The MS sends a MOB_HO-IND (Mobile Handover Indication message) to the Serving BS to notify one of the Target BSs selected by the Serving BS in the Handover Preparation phase.

(2) Upon reception of the MOB_HO-IND the Serving BS sends an R6 HO_Cnf (Handover Confirm) message to the Serving ASN-GW.

(3) The Serving ASN-GW sends HO_Cnf to the target ASN-GW which the MS will handover to.

(4) The target ASN-GW sends HO_Cnf to target BS which the MS will handover to.

(5) The target BS replies to target ASN-GW with HO_ACK (Handover Acknowledge).

(6) The target ASN-GW replies to serving ASN-GW with HO_ACK.

(7) The serving ASN-GW replies to serving BS with HO_ACK.

(8) R6 data path registration between target BS and target ASN-GW.

(9) R4 data path registration between serving ASN-GW and target ASN-GW.

(10) R6 data path deregistration between serving BS and serving ASN-GW.

(11) MS sends RNG-REQ (Ranging Request) to target BS.

(12) Network re-entry procedure completes between MS and target BS.

(13),(14),(15) After successful network re-entry, target BS may send HO_Complete to target ASN-GW, target ASN-GW may send HO_Complete to serving ASN-GW, serving ASN-GW may send HO_Complete to serving BS.

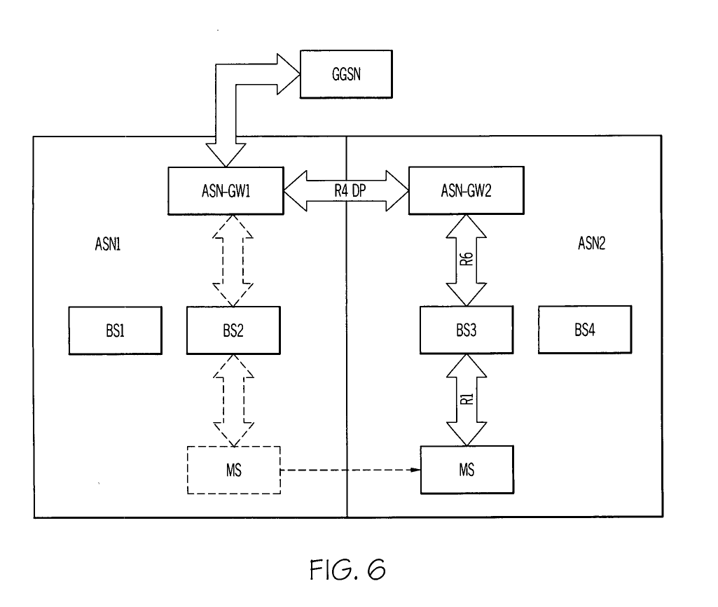

FIG. 6 shows the before and after handover configurations, wherein the dashed arrows are the old path (before handover) and the solid arrows are the new path (after handover). Thus, before handover, the connection is from the MS to BS2 to ASN-GW1 to the GGSN in the 3GPP CN. After handover, the connection is from the MS to BS3 to ASN-GW2 to ASN-GW1 to the GGSN. Note that the original Rag remains and that an R4 connection is made between ASN-GW1 and ASN-GW2.

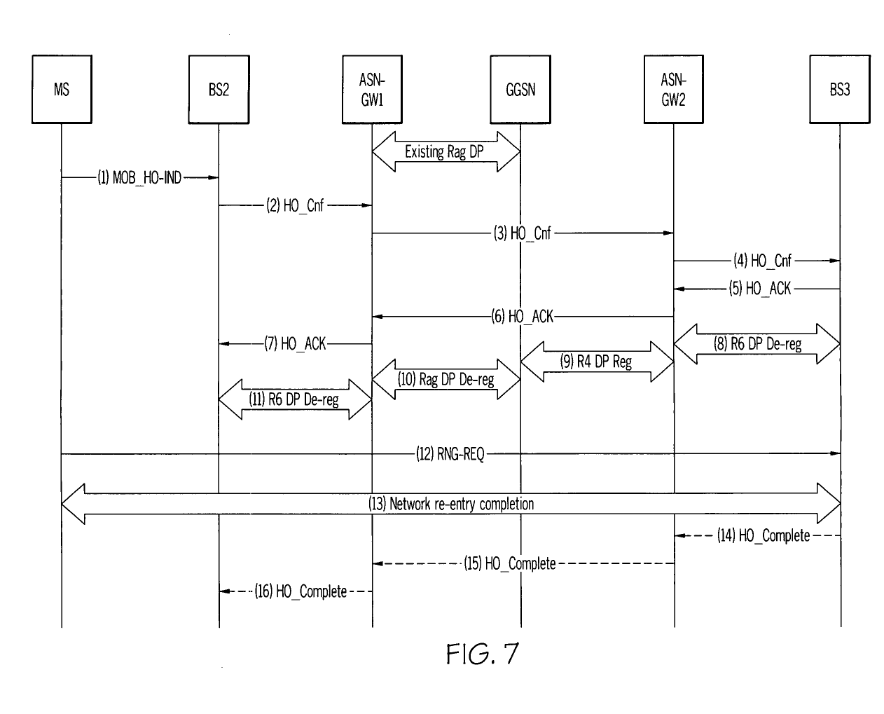

FIG. 7 shows the handover procedure when an R4 data path cannot be established between the two ASN-GWs. In this case a new Rag is established between the ASN-GW2 and the GGSN and the old Rag is broken. The PDP update procedure can be used between GGSN and ASN-GW2 to establish new Rag. The handover procedure in this case is as follows:

(1) The MS sends a MOB_HO-IND to the Serving BS to notify a handover to one of the Target BSs selected by the Serving BS in the Handover Preparation phase.

(2) Upon reception of the MOB_HO-IND the Serving BS sends an R6 HO_Cnf message to Serving ASN-GW.

(3) Serving ASN-GW sends HO_Cnf to the target ASN-GW which the MS will handover to.

(4) The target ASN-GW sends HO_Cnf to target BS which the MS will handover to.

(5) The target BS replies to target ASN-GW with HO_ACK.

(6) The target ASN-GW replies to serving ASN-GW with HO_ACK.

(7) The serving ASN-GW replies to serving BS with HO_ACK.

(8) R6 data path registration between target BS and target ASN-GW.

(9) Rag data path registration between target ASN-GW and GGSN. Update PDP Context Request/Response can be used here between target ASN-GW and GGSN.

(10) Rag data path deregistration between serving ASN-GW and target ASN-GW. Delete PDP Context Request/Response can be used here between serving ASN-GW and GGSN. This procedure can be triggered by GGSN.

(11) R6 data path deregistration between serving BS and serving ASN-GW.

(12) MS sends RNG-REQ to target BS.

(13) Network re-entry procedure completes between MS and target BS.

(14),(15),(16) After successful network re-entry, target BS may send HO_Complete to target ASN-GW, target ASN-GW may send HO_Complete to serving ASN-GW, serving ASN-GW may send HO_Complete to serving BS.

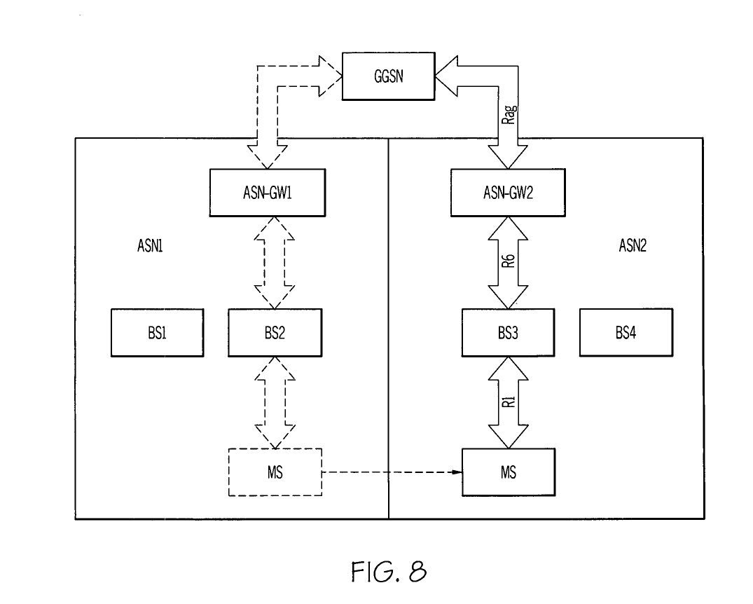

FIG. 8 shows the before and after handover configurations, wherein the dashed arrows are the old path (before handover) and the solid arrows are the new path (after handover). Thus, before handover, the connection is from the MS to BS2 to ASN-GW1 to the GGSN in the 3GPP CN. After handover, the new path is from MS to BS3 to ASN-GW2 to the GGSN.

Thus, one embodiment is a WiMAX communications system capable of communication with a 3GPP network. The system comprises a first ASN-GW within an ASN to communicate control information between a base station and a WiMAX AAA server located in the 3GPP network. The system further comprises a GTP mechanism to implement GTP functionality in the ASN to enable the first ASN-GW to communicate data between itself and a GGSN of the 3GPP network.

In some embodiments, the first ASN-GW communicates with the WiMAX AAA server through an AAA proxy server located in a visited network of the 3GPP network. In some embodiments, the first ASN-GW supports a charging path between the first ASN-GW and the WiMAX AAA server within the 3GPP network. Some embodiments implement a handover procedure in communication with the GGSN and a second ASN-GW in response to a signal from a mobile station. In one embodiment, the first ASN-GW implements a handover procedure that establishes a link between the first ASN-GW and a second ASN-GW. Or, in the same or a different embodiment, the first ASN-GW may implement a handover procedure that establishes a link between the GGSN of the 3GPP network and the second ASN-GW.

Another embodiment is a 3GPP communications system capable of communication with a WiMAX network. The system comprises a WiMAX AAA server to communicate control information between itself and a first ASN-GW of the WIMAX network. The system further comprises a GGSN to communicate data between itself and the first ASN-GW by way of GTP functionality implemented in the WIMAX network. In some embodiments, the system further comprises a MAP mechanism to implement MAP functions to enable communication between the WiMAX AAA server and an HLR of the 3GPP system. Also, in some embodiments, the GGSN implements steps in a handover procedure in communication with the first ASN-GW and in communication with a second ASN-GW in response to a signal from a mobile station. In one handover procedure, a link is established between the first ASN-GW and a second ASN-GW. In another handover procedure, a link is established between the GGSN and a second ASN-GW in the WiMAX network.

Yet another embodiment is a method for enabling communications between a WiMAX network and a 3GPP network. The method comprises implementing GTP functions in an ASN of the WiMAX network to enable communication of user data between a first ASN-GW of the ASN and a GGSN of the 3GPP network. The method further comprises implementing a WiMAX AAA server in a home network of the 3GPP network, the WiMAX AAA server to enable communication of control information between the WiMAX network and the 3GPP network.

The method may further comprise enabling communications between the first ASN-GW and the WiMAX AAA server by implementing there between, an AAA Proxy server located in a visited network of the 3GPP network. In some embodiments, the method comprises providing MAP functionality between the WiMAX AAA server and a HLR of the home network of the 3GPP network. The method may also comprise providing a charging path between the first ASN-GW and the WiMAX AAA server. The method may also comprise providing a charging path between the WiMAX AAA server and an OFCS in the 3GPP network. In one embodiment, the method comprises implementing a handover procedure to handover a mobile station from the first ASN-GW to a second ASN-GW. In another embodiment, the method comprises establishing an interface between a GGSN of the 3GPP network and the second ASN-GW. The same or another embodiment may also comprise establishing an R4 data path between the first ASN-GW and second ASN-GW

The present invention and some of its advantages have been described in detail for some embodiments. It should be understood that various changes, substitutions and alterations can be made herein without departing from the spirit and scope of the invention as defined by the appended claims. An embodiment of the invention may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from the disclosure of the present invention that processes, machines, manufacture, compositions of matter, means, methods, or steps, presently existing or later to be developed are equivalent to, and fall within the scope of, what is claimed. Accordingly, the appended claims are intended to include within their scope such processes, machines, manufacture, compositions of matter, means, methods, or steps.

What is claimed is:

1. A method for enabling communications between a Worldwide Interoperability for Microwave Access (WiMAX) network and a 3^{rd} Generation Partnership Project (3GPP) network, comprising:
implementing General Packet Radio Service (GPRS) Tunneling Protocol (GTP) functions in an Access Service Network (ASN) of the WiMAX network to enable communication of user data between a first ASN Gateway (ASN-GW) of the ASN and a Gateway GPRS Support Node (GGSN) of the 3GPP network; and
implementing a WiMAX Authentication, Authorization and Accounting (AAA) server in a home network of the 3GPP network, the WiMAX AAA server to enable communication of control information between the WiMAX network and the 3GPP network.

2. The method of claim 1, further comprising enabling communications between the first ASN-GW and the WiMAX AAA server by implementing there between, an AAA Proxy server located in a visited network of the 3GPP network.

3. The method of claim 1, further comprising providing Mobile Application Part (MAP) functionality between the WiMAX AAA server and a Home Location Register (HLR) of the home network of the 3GPP network.

4. The method of claim 1, further comprising providing a charging path between the first ASN-GW and the WiMAX AAA server.

5. The method of claim 1, further comprising providing a charging path between the WiMAX AAA server and an Offline Charging System (OFCS) in the 3GPP network.

6. The method of claim 1, further comprising providing a charging path between the WiMAX AAA server and an Online Charging System (OCS) in the 3GPP network.

7. The method of claim 1, further comprising implementing a handover procedure to handover a mobile station from the first ASN-GW to a second ASN-GW.

8. The method of claim 7, wherein the handover procedure comprises establishing an interface between a GGSN of the 3GPP network and the second ASN-GW.

9. The method of claim 7, wherein the handover procedure comprises establishing an R4 data path between the first ASN-GW and second ASN-GW

10. A Worldwide Interoperability for Microwave Access (WiMAX) communications system capable of communication with a 3^{rd} Generation Partnership Project (3GPP) network, comprising:
a first Access Service Network Gateway (ASN-GW) within an ASN to communicate control information between a base station and a WiMAX Authentication, Authorization and Accounting (AAA) server located in the 3GPP network;
a General Packet Radio Service (GPRS) Tunneling Protocol GTP mechanism to implement GTP functionality in the ASN to enable the first ASN-GW to communicate data between itself and a Gateway GPRS Support Node (GGSN) of the 3GPP network.

11. The system of claim 10, wherein the first ASN-GW communicates with the WiMAX AAA server through an AAA proxy server located in a visited network of the 3GPP network.

12. The system of claim 10, wherein the first ASN-GW supports a charging path between the first ASN-GW and the WIMAX AAA server within the 3GPP network.

13. The system of claim 10, wherein the first ASN-GW implements a handover procedure in communication with the GGSN and a second ASN-GW in response to a signal from a mobile station.

14. The system of claim 10, wherein the first ASN-GW implements a handover procedure that establishes a link between the first ASN-GW and a second ASN-GW.

15. The system of claim 10, wherein the first ASN-GW implements a handover procedure that establishes a link between the GGSN of the 3GPP network and the second ASN-GW.

16. A 3^{rd} Generation Partnership Project (3GPP) communications system capable of communication with a Worldwide Interoperability for Microwave Access (WiMAX) network, comprising:
a WiMAX Authentication, Authorization and Accounting (AAA) server to communicate control information between itself and a first Access Service Network Gateway (ASN-GW) of the WiMAX network;
a Gateway General Packet Radio Service (GPRS) Support Node (GGSN) to communicate data between itself and the first ASN-GW by way of GTP functionality implemented in the WiMAX network.

17. The system of claim 16, further comprising a Mobile Application Part (MAP) mechanism to implement MAP functions to enable communication between the WiMAX AAA server and a Home Location Register (HLR) of the 3GPP system.

18. The system of claim 16, wherein the first GGSN implements steps in a handover procedure in communication with the first ASN-GW and in communication with a second ASN-GW in response to a signal from a mobile station.

19. The system of claim 16, wherein the GGSN implements steps in a handover procedure that establishes a link between the first ASN-GW and a second ASN-GW.

20. The system of claim 16, wherein the GGSN implements a handover procedure that establishes a link between the GGSN and a second ASN-GW in the WIMAX network.
